(19) United States
(12) Patent Application Publication
(10) Pub. No.: US 2014/0149976 A1
(43) Pub. Date: May 29, 2014

(54) INFORMATION PROCESSING SYSTEM, INFORMATION PROCESSING METHOD, AND RECORDING MEDIUM STORING AN INFORMATION PROCESSING PROGRAM

(71) Applicants: Yutaka Yagiura, Kanagawa (JP); Yoh Masuyama, Kanagawa (JP)

(72) Inventors: Yutaka Yagiura, Kanagawa (JP); Yoh Masuyama, Kanagawa (JP)

(21) Appl. No.: 14/075,245

(22) Filed: Nov. 8, 2013

(30) Foreign Application Priority Data
Nov. 28, 2012 (JP) 2012-259808

(51) Int. Cl. G06F 9/445

(52) U.S. Cl. CPC G06F 8/65
USPC 717/173

(57) ABSTRACT

In an information processing system, each of an operational part and the operating working part has its own operating system. In case of adding or updating a function that the information processing system implements, the operational part downloads data for adding or updating the function.

### CROSS-REFERENCE TO RELATED APPLICATION

This patent application is based on and claims priority pursuant to 35 U.S.C. §119 to Japanese Patent Application No. 2012-259808, filed on Nov. 28, 2012 in the Japan Patent Office, the entire disclosure of which is hereby incorporated by reference herein.

### BACKGROUND

1. Technical Field

The present invention relates to an information processing system, an information processing method, and recording medium storing an information processing program.

2. Background Art

Conventionally, in an information processing apparatus such as a multifunctional peripheral (MFP), an operational part and a working part (main unit) are set up separately. In that case, the working part performs various processes in response to a user's operation accepted by the operational part, and the operational part displays a status of the working part.

Also, an information processing apparatus like that described above is communicably connected to an external server, and the information processing apparatus adds or updates functions by downloading programs and other such data from the external server and installing them. In order to add or update functions, the information processing apparatus either installs a new program or updates an existing program, etc.

### SUMMARY

Example embodiment of the present invention provides an information processing system that includes an operational unit that accepts input and an operating unit that executes processing information based on the input accepted by the operational unit. Each of the operational unit and the operating unit has its own operating system (OS). In case of adding or updating a function that the information processing system implements, the operational unit in the information processing system downloads data for adding or updating the function.

Example embodiments of the present invention include an information processing method executed by the information processing system that includes an operational unit to accept input and an operating unit to execute processing information based on the input accepted by the operational unit, and each of the operational unit and the operating unit has its own operating system, and a non-transitory recording medium storing a program that causes the computer to implement the information processing method.

### BRIEF DESCRIPTION OF THE DRAWINGS

A more complete appreciation of the disclosure and many of the attendant advantages thereof will be readily obtained as the same becomes better understood by reference to the following detailed description when considered in conjunction with the accompanying drawings.

FIG. 1 is a diagram illustrating an image processing system as an embodiment of the present invention.

FIG. 2 is a block diagram illustrating a hardware configuration of the image processing system shown in FIG. 1.

FIG. 3 is a diagram illustrating a functional configuration of a main unit and an operational part shown in FIG. 2.

FIG. 4 is a sequence diagram illustrating a process of adding or updating a function in the image processing system shown in FIG. 1.

### DETAILED DESCRIPTION

In describing preferred embodiments illustrated in the drawings, specific terminology is employed for the sake of clarity. However, the disclosure of this patent specification is not intended to be limited to the specific terminology so selected, and it is to be understood that each specific element includes all technical equivalents that have the same function, operate in a similar manner, and achieve a similar result.

When an information processing apparatus downloads and installs a program or other data, use of functions of the information processing apparatus is limited in some cases. For example, if an information processing apparatus provides a predefined function by controlling a mechanical driving unit, sometimes the information processing apparatus is designed to stop providing the function during the download and installation to prevent destabilizing such control.

In the following embodiment, an information processing system is provided that includes an operational unit that accepts input, such as inputting a command and an operating unit that executes processing information based on the input, such as the command accepted by the operational unit. Each of the operational unit and the operating unit has its own operating system (OS). In case of adding or updating a function implemented in the information processing system, the operational unit downloads data for adding or updating a function that the information processing system implements.

In this configuration, the information processing system can easily add or update a function with minimal impact on function availability.

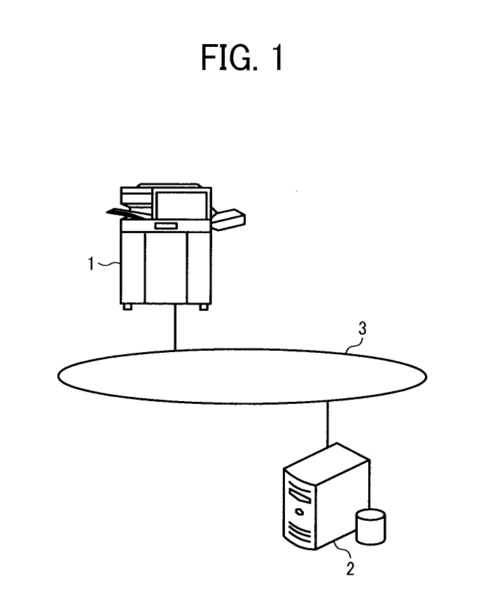

FIG. 1 is a diagram illustrating an image processing system as an embodiment of an information processing apparatus of the present invention.

In the present embodiment, an image processing system 1 is a MFP that includes communication functions as well as functions such as printing, scanning, and facsimile. A user can operate the image processing system 1 directly and instruct the image processing system to process these functions. Otherwise, the image processing system 1 can execute the functions in response to a command received from an external apparatus such as a client personal computer (PC).

The image processing system 1 can communicate with a distribution server 2 that distributes data for adding or updating functions of the image processing system 1 via a network 3. The distribution server 2 distributes data such as a new program like OS, firmware, and applications, an update program, and data to be browsed like a manual.

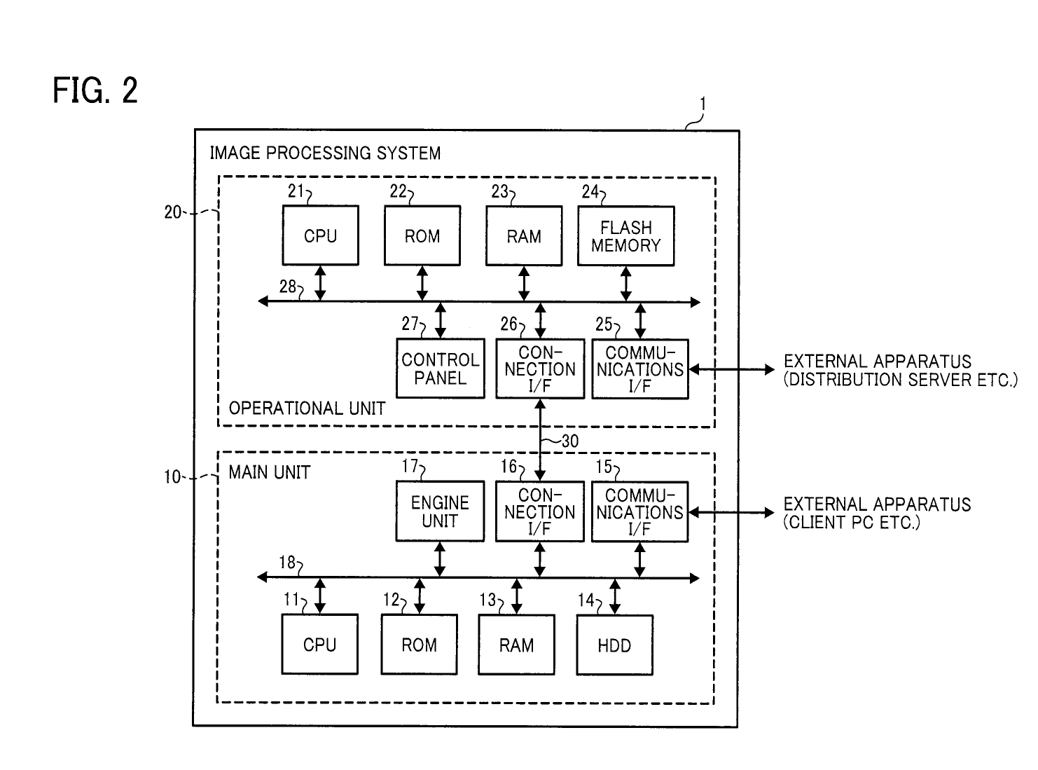

FIG. 2 is a block diagram illustrating a hardware configuration of the image processing system 1 shown in FIG. 1. As shown in FIG. 2, the image processing system 1 includes an operational part 20 that accepts inputting a command by a user and a main unit 10 as a working part that works based on the command accepted by the operational part 20. In the image processing system 1, the operational part 20 and the main unit 10 can communicate with each other via a communication channel 30.

The main unit 10 can perform an operation in response to not only a command accepted by the operational part 20 but also a command received from the external apparatus as described above. In the present embodiment, the communications channel 30 is compliant with Universal Serial Bus (USB) specification, for example, although the communications channel 30 can be compliant with any wired or wireless specification. Also, the communications channel 30 can be not only one-to-one but also a network. Other than USB, e.g., serial, wired local area network (LAN), wireless LAN, Bluetooth, and Infrared Data Association (IrDA) can be used for the communication channel 30.

The main unit 10 includes a CPU 11, a ROM 12, a RAM 13, a hard disk drive (HDD) 14, a communications interface (I/F) 15, a connection I/F 16, and an engine unit 17, all connected to a system bus 18. The main unit 10 as a whole is controlled by the CPU 11 executing a program stored in the ROM 12 or the HDD 14 using the RAM 13 as a work area. Also, various functions, such as controlling communication with the operational part 20 described later and controlling adding and updating a function, are implemented by the CPU 11 executing a program stored in the ROM 12 or the HDD 14 using the RAM 13 as a work area.

The HDD 14 is a nonvolatile storage medium (storage unit) and stores various programs executed by the CPU 11 and various data including main unit configuration information (working part configuration information) that indicates hardware and software configurations of the main unit 10. These various programs and data can be stored in the ROM 12.

The communications I/F 15 is an interface to communicate with an external apparatus such as a client PC (not shown in figures) via the network 3.

The connection I/F 16 is an interface to communicate with the operational part 20 via the communication channel 30. In this embodiment, an interface compliant with USB specification is used for the connection I/F 16. However, any specification whether wired or wireless can be adopted as the communications I/F 15 and the connection I/F 16. One I/F can double as the communications I/F 15 and the connection I/F 16. Conversely, the main unit 10 can include three or more I/Fs used for communicating.

The engine unit 17 is hardware that executes processes to implement the printing function, scanning function, copying function, and facsimile function except general-purpose information processing and communication. For example, the engine unit 17 includes a scanner (an image scanning unit) that scans a document to create and image thereof, a plotter (an image forming unit) that performs printing on sheet material such as paper, and a communication unit that performs facsimile communication, etc. Furthermore, the engine unit 17 can include specific options such as a finisher that sorts printed sheet material and an Auto Document Feeder (ADF) that feeds documents automatically.

The operational part 20 includes a CPU 21, a ROM 22, a RAM 23, a flash memory 24, a communications I/F 25, a connection I/F 26, and a control panel 27, all connected to a system bus 28. The whole of the operational part 20 is controlled by the CPU 21 by executing a program stored in the ROM 22 or the flash memory 24 using the RAM 23 as a work area. Also, various functions such as controlling communication with the main unit 10 and controlling adding and updating a function are implemented by the CPU 21 by executing a program stored in the ROM 22 or the flash memory 24 using the RAM 23 as a work area.

The flash memory 24 is a nonvolatile storage medium (storage unit) and stores various programs executed by the CPU 21 and various data including main unit configuration information that indicates a hardware and software configuration of the operational part 20. These various programs and data can be stored in the ROM 22.

The communications I/F 25 is an interface to communicate with an external apparatus such as the distribution server 2 via the network 3.

The connection I/F 26 is an interface to communicate with the main unit 10 via the communication channel 30. In this embodiment, an interface compliant with USB specification is used for the connection I/F 26. However, any specification, whether wired or wireless, can be adopted as the communications I/F 25 and the connection I/F 26. One I/F can double as the communications I/F 25 and the connection I/F 26. Conversely, the operational part 20 can include more than three I/Fs used for communicating.

The control panel 27 is an operational display unit that includes an operational part that accepts commands to execute various operations and an operation to configure, etc., and a display part that displays operational status and configuration of the image processing system 1. For example, the control panel 27 can be comprised of a liquid crystal display (LCD) panel on which a touch panel is laminated. Furthermore, in addition to or instead of an LCD panel, an operational part such as hardware keys and a display part such as a lamp can be set up.

In the image processing system 1 described above, each of the main unit 10 and the operational part 20 can be equipped with an OS individually, and the main unit 10 and the operational part 20 can work independently. Communication between the main unit 10 and the operational part 20 is performed not as interprocess communication within an apparatus but communication between different apparatuses.

Examples of the communication between the main unit 10 and the operational part 20 include notifying the main unit 10 of a content of a user's command accepted by the operational part 20, and notifying the operational part 20 of information to be displayed on the operational part 20 from the main unit 10. Examples of the information to be displayed on the operational part 20 are execution status of operations in the main unit 10, and content of configuration settings in the main unit 10.

The distribution server 2 can be comprised of a known computer that includes the CPU, the ROM, the RAM, and the communication I/F etc.

A process of adding or updating a function of the main unit 10 in the image processing system 1 will be described in detail below.

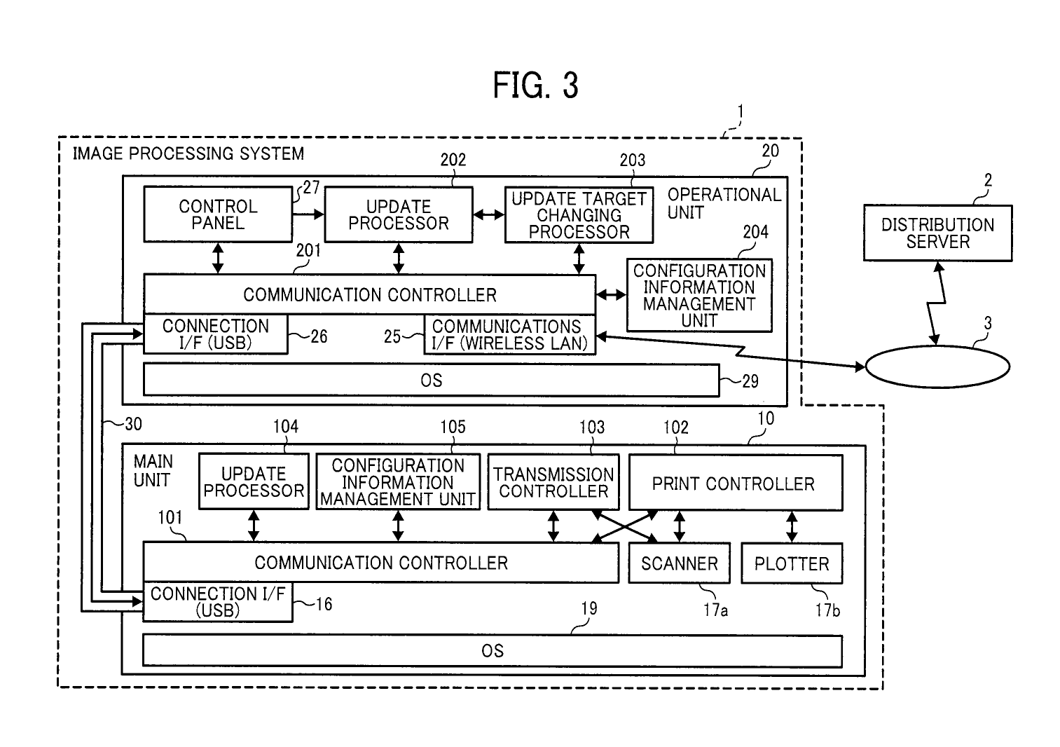

First, a functional configuration of the image processing system 1 regarding addition or update of a function of the main unit 10 will be described. FIG. 3 is a diagram illustrating a functional configuration of the main unit 10 and the operational part 20 shown in FIG. 2. In FIG. 3, units not related to addition or update of a function of the main unit 10 are omitted or abbreviated.

As shown in FIG. 3, the main unit 10 includes the connection I/F 16, a scanner 17a, a plotter 17b, OS 19, a communication controller 101, a print controller 102, a transmission controller 103, an update processor 104, and a configuration information management unit 105. As described above with reference to FIG. 2, the connection I/F 16 exchanges data with the operational part 20. It should be noted that the communications I/F 15 is omitted in FIG. 3 since it is not used for adding or updating a function of the main unit 10.

The scanner 17a and the plotter 17b illustrate the configuration of the engine unit 17 shown in FIG. 2 more specifically.

The OS 19 is an operating system that controls the main unit 10. A known appropriate OS can be adopted as the OS 19. Also, it is unnecessary to make the OS 19 the same type as an OS 29 in the operational part 20 as long as they can communicate with each other.

The communication controller 101 includes the connection I/F 16 and is capable of controlling data communication via the communications I/F 15 (not shown in FIG. 3). After receiving data via those interfaces, the communication controller 101 passes the data to the processor to process the data among various processors such as the print controller 102, the transmission controller 103, the update processor 104, and the configuration information management unit 105 depending on a specified destination or the type of command, etc. In addition, the communication controller 101 passes data to be transmitted externally from those processors to an interface used for such transmission. Furthermore, the communication controller 101 performs exchanging data between the processors.

The print controller 102 controls the scanner 17a and the plotter 17b in the engine unit 17 and manages jobs that the engine unit 17 executes, such as a print job.

The transmission controller 103 manages transmission jobs such as fax transmission, e-mail transmission, and folder transmission (transferring data to an external apparatus in the LAN).

The update processor 104 adds or updates data stored in the ROM 12 or the HDD 14, such as a program, in order to add or update a function of the main unit 10. The update processor 104 performs the addition and update using data sent from the operational part 20, as described later.

The configuration information management unit 105 manages main unit configuration information that indicates the configuration of the hardware and software included in the main unit 10. The configuration information management unit 105 checks the status of the hardware and software included in the main unit 10 on start-up and updates the main unit configuration information in accordance with the result. In case of adding or updating software, the configuration information management unit 105 updates the main unit configuration information in accordance with the addition or update. The same goes for adding or updating data other than software related to addition or update of the function that the main unit 10 has. The main unit configuration information can be provided to the operational part 20 in response to a request from the operational part 20.

On the other hand, the operational part 20 includes the communications I/F 25, the connection I/F 26, the control panel 27, the OS 29, a communication controller 201, an update processor 202, an update target changing processor 203, and a configuration information management unit 204.

As described above with reference to FIG. 2, the communications I/F 25 exchanges data with an external apparatus such as the distribution server via the network 3. Also, as described above with reference to FIG. 2, the connection I/F 26 exchanges data with the main unit 10. Furthermore, as described above with reference to FIG. 2, the control panel 27 accepts commands to execute various operations from a user and providing various information to the user.

The OS 29 is an operating system that controls the operational part 20. A known appropriate OS can be adopted as the OS 29. Also, it is unnecessary to make the OS 29 the same type as the OS 19 in the main unit 10 as long as they can communicate with each other.

The communication controller 201 is capable of controlling data communication via the communications I/F 25 and the connection I/F 26. After receiving data via those interfaces, the communication controller 201 passes the data to the processor to process the data among various processors such as the update processor 202, the update target changing processor 203, and the configuration information management unit 204 depending on a specified destination or the type of command etc. In addition, the communication controller 201 passes data to be transmitted externally from those processors to an interface used for the transmission. Furthermore, the communication controller 201 performs exchanging data between the processors.

The update processor 202 accesses the distribution server 2 preset as an access target and downloads data such as a program to add or update a function in the image processing system 1 from the distribution server 2. The added or updated function is included not only in the operational part 20 but also in the main unit 10. Also, the update processor 202 acquires a list of available data to be added or updated from the distribution server 2 prior to starting downloading.

The update target changing processor 203 determines whether the data to add or update a function downloaded from the distribution server 2 is to be used in the operational part 20 or in the main unit 10. Also, if the data is to be used in the operational part 20, the update target changing processor 203 configures the data to be usable in the operational part 20. Alternatively, if the data is to be used in the main unit 10, the update target changing processor 203 sends the data to the main unit 10 and having the data configure to be usable in the main unit 10.

Here, in case the data is a program, “configuration” means installing the program to be able to execute it. In case the data is a document file or configuration data, “configuration” means storing it to be able to browse it if needed.

The functions of the update processor 202 and the update target changing processor 203 will be described in detail later along with the function of the update processor 104 in the main unit 10.

The configuration information management unit 204 is manages operational part configuration information that indicates the configuration of the hardware and software included in the operational part 20. The configuration information management unit 204 performs the management in the same way as the configuration information management unit 105 in the main unit 10 does.

In the image processing system 1 described above, in case of adding or updating a function included in the image processing system 1, the operational part 20 downloads the data for adding or updating the function regardless of whether the function is included in the operational part 20 or the main unit 10.

Operation of each of the above-described units in adding or updating a function is described below.

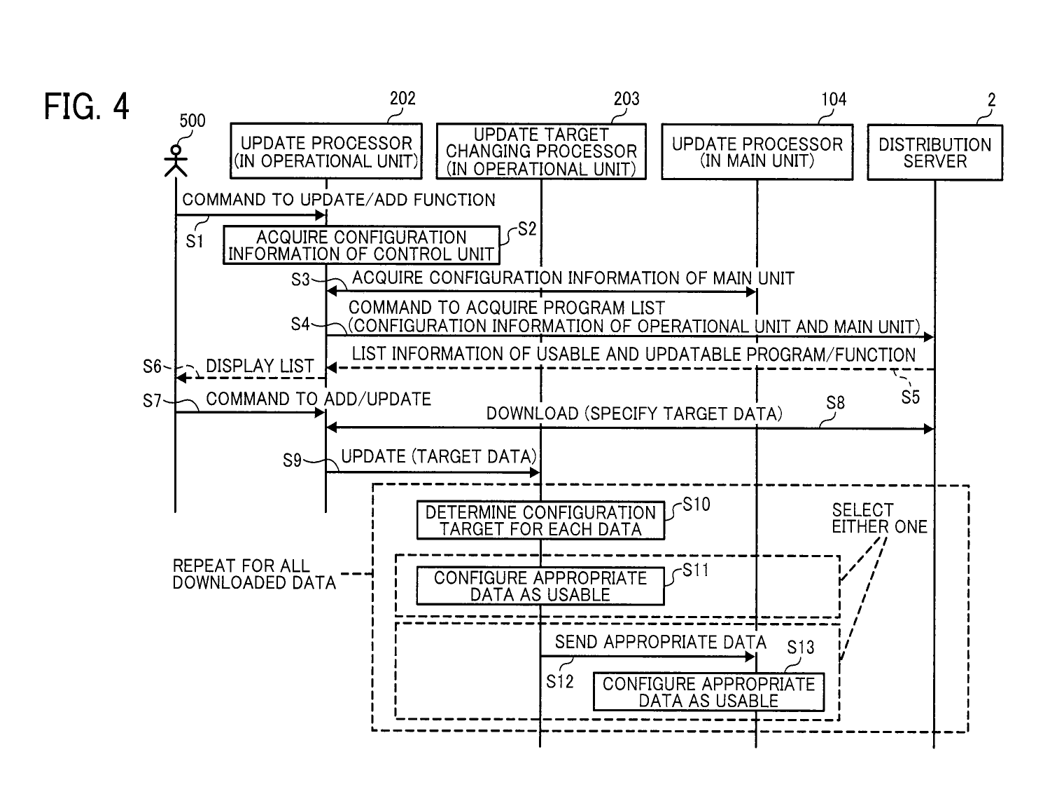

FIG. 4 is a sequence diagram illustrating a process of adding or updating a function included in the image processing system 1 shown in FIG. 1. In FIG. 4, the addition or update of the function is performed in response to a command from a user.

In FIG. 4, the operational part 20 receives a user instruction to add or update the function included in the image processing system 1 through the control panel 27 from a user 500 in S1. Subsequently, a controller (not shown in figures) passes the command to the update processor 202.

After receiving the command, first, the update processor 202 acquires the operational part configuration information from the configuration information management unit 204 in S2. This step is described in detail later.

Also, the update processor 202 requests the update processor 104 in the main unit 10 to send the main unit configuration information. Subsequently, the update processor 104 acquires the main unit configuration information acquired from the configuration information management unit 105 and sends it to the update processor 202 in response to the request in S3. This step is also described in detail later.

Next, the update processor 202 sends the operational part configuration information acquired in S2 and the main unit configuration information acquired in S3 to the distribution server 2 and acquires the list for adding or updating the functions available in the operational part 20 or the main unit 10 in S4 and S5.

Particular examples of each configuration information are described later. In this case, the distribution server 2 searches for functions available for the operational part 20 and the main unit 10 from the list for adding or updating functions distributable from the distribution server 2. The functions can be available only for the operational part 20, only for the main unit 10, or for a combination of the operational part 20 and the main unit 10.

For example, a function implemented by a program determined to be executable on the main unit 10 based on the main unit configuration information among programs found to be not installed in the main unit 10 yet based on the main unit configuration information can be selected for addition to the main unit 10.

Otherwise, a function implemented by a program determined to be updatable to a new version among programs found to be already installed in the main unit 10 based on the main unit configuration information can be selected for updating in the main unit 10, on the condition that the main unit 10 is equipped with the appropriate hardware and OS, etc., to execute the new version of the program.

The operational part 20 can perform these determinations in the same way as described above with reference to the operational part configuration information. In addition, these determinations can be performed in the same way as described above in case the data to be added or updated is a document file such as a manual. In this case, it is also considered whether the operational part 20 or the main unit 10 is equipped with applications to reference the content of the document file or not.

In either case, after acquiring the list of available functions to be added or updated in S5, the update processor 202 instructs the control panel 27 to display the list to be browsed by the user in S6.

Next, the operational part 20 receives commands to add or update the function, which is selected among the list as the function to be actually added or updated by the user 500 in S7. Subsequently, a controller (not shown in figures) passes the command to the update processor 202.

After receiving the command, the update processor 202 requests the distribution server 2 to send data to be added or updated in accordance with the chosen function and acquires the data from the distribution server 2 by downloading it in S8. The content of the acquired data can be a program, a document file, or configuration data. At the time of acquiring the data, it is unnecessary to consider whether the function to be added or updated is included in the main unit 10 or in the operational part 20. Of course, it is unnecessary to consider whether it is the main unit 10 or the operational part 20 that utilizes the downloaded data.

After step S8, text, the update processor 202 passes the downloaded data to the update target changing processor 203 and instructs the update target changing processor 203 to configure the data in S9. The update target changing processor 203 determines for each piece of data passed from the update processor 202 whether it is used by the operational part 20 or the main unit 10 in S10.

It is possible to perform the determination described above by analyzing the data itself. However, in many cases, the distribution server 2 provides the data for adding or updating the function while adding additional information thereto that indicates to which function the data is related. Therefore, if the update processor 202 provides the data along with the additional data to the update target changing processor 203, the update target changing processor 203 can perform the determination in S10 based on the additional information.

Next, if it is determined that the data is to be used by the operational part 20 in S10, the update target changing processor 203 configures the data as usable on the operational part 20 in S11. As described above, in case the data is a program, “configuration” means installing it to be able to execute it. In case the data is a document file or configuration data, “configuration” means storing it to be able to browse it if needed.

Otherwise, if it is determined that the data is to be used by the main unit 10 in S10, the update target changing processor 203 sends the data to the update processor 104 in the main unit 10 via the connection I/Fs 26 and 16 and requests the main unit 10 to configure the data in S12. After receiving the request, the update processor 104 configures the data as usable on the main unit 10 in S13.

After executing steps from S10 to S13 for all data downloaded in S8, the process shown in FIG. 4 ends.

In the steps shown in FIG. 4, S3 corresponds to the function of the acquisition unit, S10 corresponds to the function of the determination unit, and S11 and S12 correspond to the function of data processor.

By executing the process described above, in the image processing system 1, the operational part 20 downloads the data for adding or updating the function regardless of whether the function to be added or updated is implemented in the operational part 20 or the main unit 10 in case of adding or updating the function.

Therefore, during the download of the data, the main unit 10 is not burdened with a process related to the addition or update of the function except for providing the main unit configuration information to the operational part 20 in response to the request from the operational part 20. Consequently, the main unit 10 can execute any job without a risk that the control becomes unstable in accordance with the addition or update of the function.

For example, if a program in the image processing system 1 is to be updated while the image processing system 1 is printing or faxing, it is unnecessary to stop printing or faxing at least until the step in S12 shown in FIG. 4. The same applies to a case in which the image processing system 1 executes these jobs while the image processing system receives data for printing or faxing from an external client PC. Consequently, it is possible to add or update a function easily with decreasing effect on providing capabilities by the main unit 10.

If the main unit 10 is executing a job whose control stability is important in the process shown in FIG. 4, it is possible to execute the step in S12 after waiting for the job to finish. On the other hand, regarding the operational part 20, since the main functions of the operational part 20 are to accept input and to display various information, it is not a major problem if control of the operational part 20 becomes unstable even if adding or updating a function becomes a burden on the processing capacity of the operational part 20.

When the main unit 10 receives data sent in S12 and executes configuration in S13 shown in FIG. 4, it is unavoidable to generate processing load to a certain level. However, the total amount of the processing load and the period in which the processing load is generated can be fairly reduced compared to performing the complete process including downloading data for the addition or update from the server 2.

Also, since each of the operational part 20 and the main unit is equipped with its own OS, the operation of the main unit 10 is not affected even if the operational part 20 executes a processing-intensive operation.

In the image processing system 1, after acquiring the main unit configuration information from the main unit 10, the operational part 20 sends the main unit configuration information to the distribution server 2 and the distribution server 2 provides data for the addition or update available for the main unit 10 based on the main unit configuration information. Therefore, if the operational part 20 downloads data available for the main unit 10, a situation in which the data cannot be configured since hardware or software requirements are not satisfied at the time of configuration can be avoided.

In addition, the operational part 20 determines that the downloaded data for the addition or update is to be used either by the operational part 20 itself or by the main unit 10. In the former case, the operational part 20 configures the data in the operational part 20. In the latter case, the operational part 20 sends the data to the main unit 10. Therefore, if the operational part 20 downloads data available for the main unit 10, and data that will be used in the operational part 20 and data that will be used in the main unit 10 are mixed together, it is possible to distinguish the data and configure it in the appropriate unit.

TABLE 1 illustrates the operational part configuration information managed by the configuration information management unit 204 in the operational part 20. The operational part configuration information shown in TABLE 1 includes information on a model name of the operational part 20 (type of the panel), version (firmware version), installed hardware (list of hardware included in the operational part 20), and installed programs (list of programs included in the operational part 20).

TABLE 1

| Information name | Explanation | Examples of value |
|---|---|---|
| Model name | Type of panel | PanelTypeA |
| Version | Firmware version | 1.0.0 |
| Installed | List of hardware included | Camera, Bluetooth, GPS |
| hardware | in the operational part | |
| Installed | list of programs included | Platform, Ver.1.0.0 |
| programs | in the operational part | Web Browser, Ver.1.0.0 |
| | | EcoCopy, Ver.1.2 |
| | | CloudScanner, Ver.2.0 |
| | | Manual for the main unit, |
| | | model type Type AAZ, |
| | | Ver.1.0 |
| | | Manual for the main unit, |
| | | model type Type BBX, |
| | | Ver.1.0 |

TABLE 2 illustrates the main unit configuration information managed by the configuration information management unit 105 in the main unit 10. The main unit configuration information shown in TABLE 2 includes information on a model name of the main unit 10 (type of the image forming apparatus), version (firmware version), installed options (list of hardware included in the main unit 10), installed programs (list of programs included in the main unit 10).

TABLE 2

| Information name | Explanation | Examples of value |
|---|---|---|
| Model name | Type of image forming | MFP Type AAZ |
| | apparatus | |
| Version | Firmware version | 1.3.0 |
| Installed | List of hardware included | Finisher Type A, Ver.1.0 |
| options | in the main unit | ADF Type S, Ver.1.2 |
| Installed | list of programs included | Platform, Ver.1.0.0 |
| programs | in the main unit | BarcodePrint, Ver.1.6.0 |
| | | PDFPrintOption, |
| | | Ver.1.4.0 |
| | | ClearLightPDFScan, |
| | | Ver.1.0.0 |

The distribution server 2 can extract the data available for the operational part 20 or the main unit 10 from data for the addition or update that the distribution server 2 itself can provide based on the configuration information sent from the operational part 20 described above.

For example, that can be implemented by registering additional information such as model name of the unit that will use the data, version of firmware and platform necessary for using the data, and hardware and software necessary for using the data for each piece of data, and comparing the additional information with the sent configuration information. Consequently, it can be determined whether or not the operational part 20 and the main unit 10 satisfy requirements for using the data.

Some programs require specific hardware such as a camera, Bluetooth, finisher, and Auto Document Feeder (ADF) for operation. Especially, since it is difficult to distinguish hardware that can be installed optionally by its model name, it is necessary to refer to the configuration information of the hardware.

Also, in some cases, it is required that specific software such as a browser or a PDF printing function be available. Since software is installed or uninstalled at will, it is effective to refer to the configuration information to ascertain the configuration at the time of requesting downloading.

The embodiment described above can be implemented by having a computer execute a program that implements functions described above by the CPU 21 that controls the operational part 20.

The program can be stored in a HDD, a ROM, or other nonvolatile storage media (flash memory or EEPROM etc.) included in the computer preliminarily. Also, it can be provided storing nonvolatile storage media such as CD-ROM, memory card, flexible disk, MO, CD-R, CD-RW, DVD+R, DVD+RW, DVD-R, DVD-RW, or DVD-RAM etc. Steps described above can be executed by installing the program stored in the storage media on the computer and executing it. Furthermore, it is possible to download the program from an external apparatus that includes the storage media that stores the program or stores the program in a storage unit, install the program in the computer, and execute it.

In the present invention, the specific configuration of each unit, content of process, and sequence of communication is not limited to the embodiment described above. For example, while the image processing system 1 is comprised of the main unit 10 and the operational part 20 fixedly in the embodiment described above, the image processing system 1 is not limited to that example.

The operational part and the main unit (operating unit) can be completely separated hardware components. For example, the image processing system or the information processing system can be comprised of a mobile device such as a smartphone as the operational part and the image processing apparatus such as the MFP as the operating unit. Especially, in case the operational part is connected with the operating unit using wireless communication, these units can be configured as completely independent apparatuses.

In addition, it is unnecessary that the operational part corresponds to the operating unit on a one-on-one basis. For example, it is possible that the mobile device can operate the image processing apparatus that includes the operational part connected to the main unit by wired communication. Otherwise, multiple mobile devices can operate one image processing apparatus. Furthermore, one mobile device can operate multiple image processing apparatuses changing the operation target.

Also, it is unnecessary to implement all functions of the operating unit in one apparatus. Multiple apparatuses can implement the functions of the operating unit by cooperating with each other.

It is unnecessary that the operating unit includes the image processing engine such as the scanner or plotter. Any information processing apparatus can be used for that purpose as if it operates based on a command received by the operational part. In addition, an apparatus that performs outputting physically other than processing information can also be used.

Numerous additional modifications and variations are possible in light of the above teachings. It is therefore to be understood that, within the scope of the appended claims, the disclosure of this patent specification may be practiced otherwise than as specifically described herein.

As can be appreciated by those skilled in the computer arts, this invention may be implemented as convenient using a conventional general-purpose digital computer programmed according to the teachings of the present specification. Appropriate software coding can readily be prepared by skilled programmers based on the teachings of the present disclosure, as will be apparent to those skilled in the software arts. The present invention may also be implemented by the preparation of application-specific integrated circuits or by interconnecting an appropriate network of conventional component circuits, as will be readily apparent to those skilled in the relevant art.

What is claimed is:

1. An information processing system, comprising:
an operational unit to accept input; and
an operating unit to execute processing information based on the input accepted by the operational unit,
wherein each of the operational unit and the operating unit has its own operating system, and the operational unit downloads data for adding or updating a function that the information processing system implements.

2. The information processing system according to claim 1, wherein the operational unit comprises:
an acquisition unit to acquire operating unit configuration information that indicates configuration of the operating unit from the operating unit; and
a unit to send the operating unit configuration information acquired by the acquisition unit to a predefined access destination, and acquire data for adding or updating a function available for the operating unit from the predefined access destination.

3. The information processing system according to claim 1, wherein the operational unit comprises:
a storage unit to store operational unit configuration information that indicates configuration of the operational unit; and
a unit to send the operational unit configuration information stored in the storage unit to a predefined access destination, and acquire data for adding or updating a function available for the operational unit from the predefined access destination.

4. The information processing system according to claim 1, wherein the operational unit comprises:
a determination unit to determine whether the downloaded data for adding or updating a function is to be used by the operational unit or the operating unit; and
a data processor to configure the operational unit with the downloaded data when the determination unit determines that the data is used by the operational unit, and send the downloaded data to the operating unit when the determination unit determines that the data is to be used by the operating unit.

5. A method of processing information executed by an information processing system that comprises an operational unit and an operating unit, wherein each of the operational unit and the operating unit has its own operating system,
the method comprising the steps of:
accepting input at the operational unit,
executing processing information based on the input accepted by the operational unit; and
downloading, at the operational unit, data for adding or updating a function that the information processing system implements.

6. A non-transitory recording medium storing a program that, when executed by an information processing system that comprises an operational unit and an operating unit, wherein each of the operational unit and the operating unit has its own operating system, causes the information processing system to implement a method of processing information,
the method comprising the steps of:
accepting input at the operational unit,
executing processing information based on the input accepted by the operational unit; and
downloading, at the operational unit, data for adding or updating a function that the information processing system implements.
